(19) United States
(12) Patent Application Publication
(10) Pub. No.: US 2017/0045896 A1
(43) Pub. Date: Feb. 16, 2017

(54) Flow Controller

(71) Applicant: Caleb Atchley, Norman, OK (US)

(72) Inventor: Caleb Atchley, Norman, OK (US)

(21) Appl. No.: 15/237,346

(22) Filed: Aug. 15, 2016

Related U.S. Application Data
(60) Provisional application No. 62/205,261, filed on Aug. 14, 2015.

(51) Int. Cl. G05D 7/06; H02K 37/24; H02K 7/00; E21B 34/00; F16K 31/04

(52) U.S. Cl. CPC G05D 7/0629; E21B 34/00; F16K 31/041; H02K 7/003; H02K 37/24; E21B 43/16

(57) ABSTRACT

A device for controlling a valve situated in a pipeline. The device has a frame, housing, a motor, a coupling, a controller, and a communication module. The housing is supported on the frame and has at least one opening. The motor has a body and a rotatable shaft. The body is position within the housing and the shaft extends through the housing opening. The coupling has a first end and a second end. The first end is mounted on the shaft. The second end has an opening configured to receive a valve stem of the valve. The controller is configured to direct operation of the motor to move the valve. The communication module is configured to enable remote operation of the motor.

### CROSS REFERENCE TO RELATED APPLICATION

This application claims the benefit of U.S. Provisional Patent Application Ser. No. 62/205,261 filed on Aug. 14, 2015, the entire contents of which are incorporated herein by reference.

### FIELD

This invention relates generally to devices and methods for remote or automated control of fluid flow through a pipe.

### SUMMARY

The present invention is directed to systems for monitoring and adjusting the flow of fluid through a pipe via remote or automated control. In the present invention, devices and methods are provided for actuating a valve by rotating the valve stem with a flow controller. The flow controller has a frame and a motor supported on the frame. The motor has a rotatable shaft. A coupling connects the shaft to an existing valve stem. Turning the shaft causes the valve stem to turn such that the valve is opened or closed.

### BRIEF DESCRIPTION OF THE DRAWINGS

FIG. 1 is a partially sectional, diagrammatic view of the flow controller supported on a pipeline.

FIG. 2 is a front elevation view of the device for actuating a valve of FIG. 1 having the front cover removed to show the arrangement of the internal components.

FIG. 3 is a side view of the base member of the frame shown in FIG. 2.

FIG. 4 is a side view of the base member shown in FIG. 3 from the opposite side.

FIG. 5 a side view of the flow controller shown in FIG. 1 showing the pipeline in cross-section and the mounting frame secured to the pipeline.

FIG. 6 is a section view of the coupling shown in FIG. 2.

FIG. 7 is a bottom view of the coupling of FIGS. 2 and 6.

FIG. 8 is a top view of the coupling of FIGS. 2 and 6 showing the motor drive shaft in cross-section.

FIG. 9 is a top view of the adapter used to connect the first and second ends of the coupling.

FIG. 10 is a diagrammatic representation of a printed circuit board used in the flow controller of FIG. 1.

FIG. 11 is a perspective view of an alternative flow controller arrangement.

FIG. 12 is a top view of the platform element of the frame shown in FIG. 11.

FIG. 13 is a diagrammatic representation of the flow control system components.

### DESCRIPTION OF THE PREFERRED EMBODIMENTS

Flow of liquids or gases through pipes is used in a wide variety of applications ranging from fluid transportation and handling systems in the oil and gas industry to irrigation systems in agricultural operations. Often, fluidics applications require the ability to dynamically control the amount of material flowing through the pipe. In particular, control of fluid flow is an integral component of managing injection welts to control oil and gas production.

In a typical injection well system, pipelines incorporate flow meters to detect fluid flow rate. Conventionally, an operator is required to travel on-site to read the flow meter. In response to the flow meter data, the operator manually adjusts a valve in order to achieve the desired flow rate of fluid injected into the subterranean formation. However, the manual method is often labor-intensive and inconvenient because the operator must travel to the pipeline to check and adjust the flow rate. Moreover, the manual method is difficult to monitor and prone to user error. Thus, there is a need for new toots and methods for conveniently monitoring and adjusting fluid flow rates by remote or automated operation.

In one embodiment, the disclosed invention is a flow controller applicable to a wide variety of situations where it is desirable to control the flow of a fluid through a pipe either remotely or automatically. The device can be attached to an existing pipeline without the need for extensive modifications to the pipeline. Further, the device is adapted to receive data from a conventional flow meter. The data output by the flow meter is an analog signal indicative of the flow of a fluid through the pipe. The device converts the analog signal to a digital signal in order to read the signal from the flow meter. Then, the flow controller may automatically, or in response to a command from a remote user, adjust a valve to increase or decrease the flow of fluid to the desired flow rate. The device is advantageous because it may be attached to existing valves and does not require replacement of the existing valves or modification to pipelines.

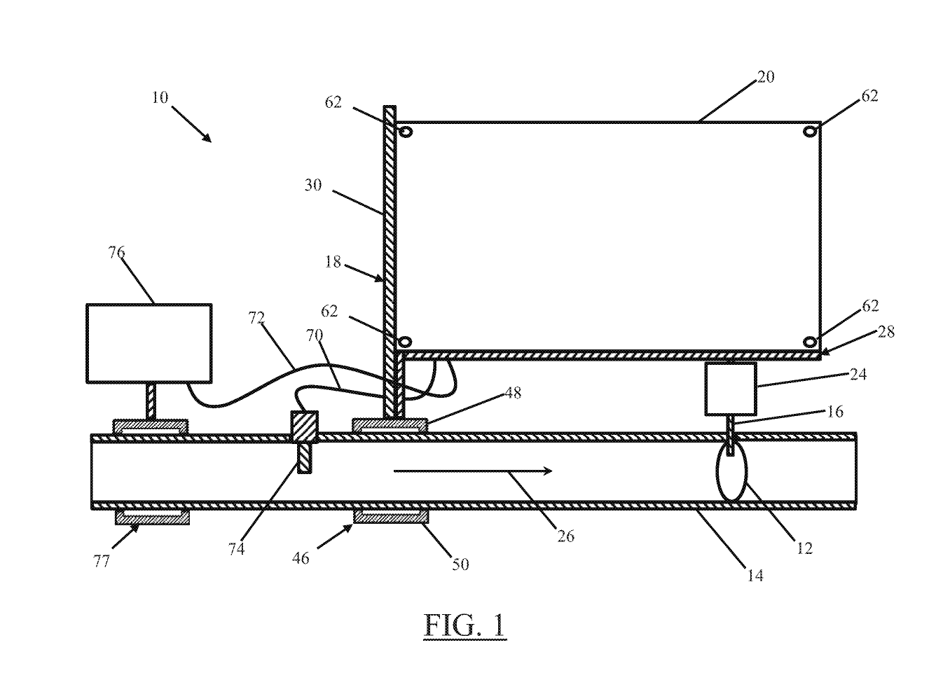

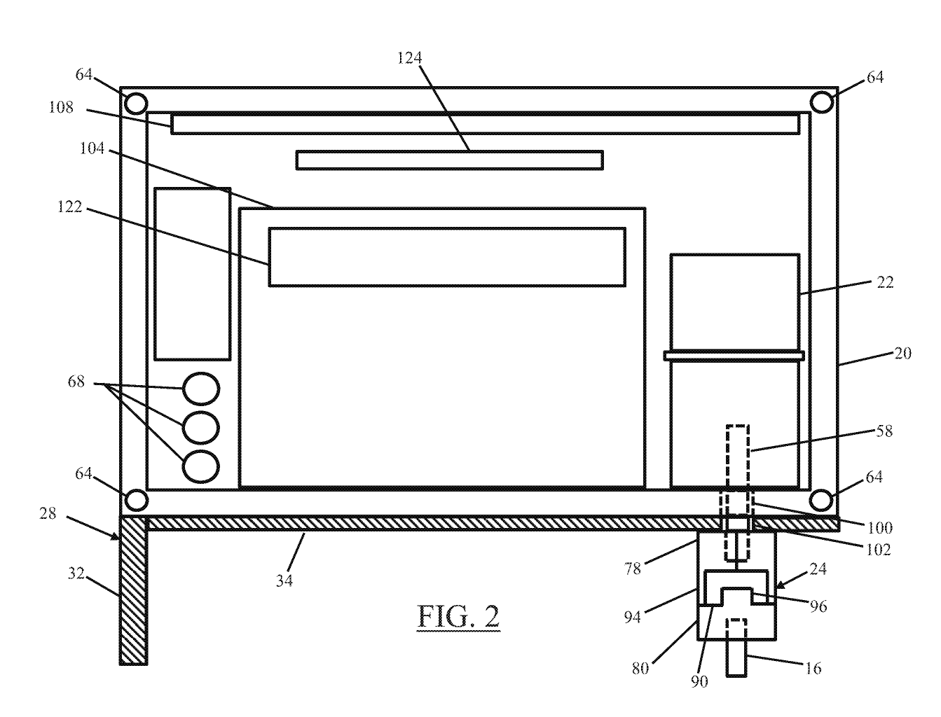

FIG. 1 shows a flow controller comprising a device 10 for actuating a valve 12, in a pipeline 14, having a valve stem 16. The device 10 comprises a frame 18, a housing 20 supported on the frame, a motor 22 (FIG. 2), and a coupling 24.

The valve 12 may be disposed between two pipe members positioned on either side of the valve. The valve has a valve stem 16 that can be turned to open and close the valve in order to control flow 26 of fluid through the pipe 14. The valve 12 may be a needle valve, a ball valve, or any other type of valve having a valve stem 16 that can be turned to actuate the valve. If the valve has a handle for turning the valve stem, the handle may be removed so that the coupling 24 can attach directly to the valve stem.

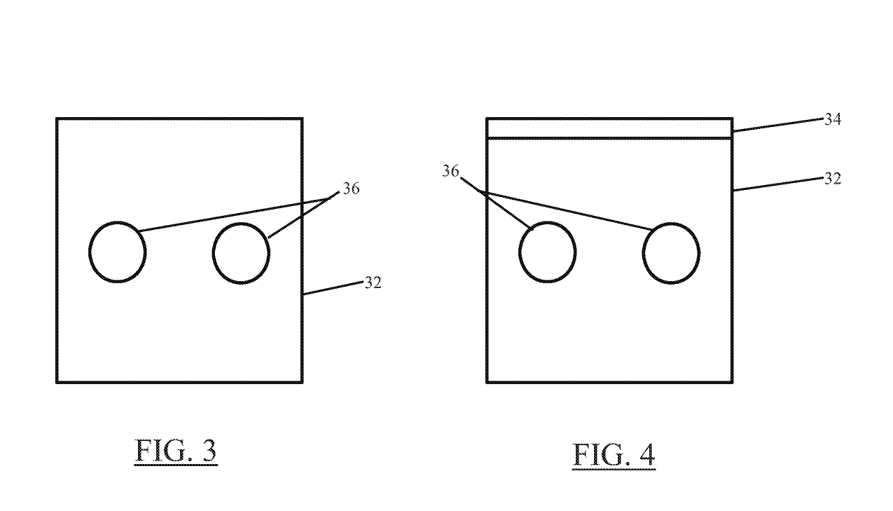

With reference to FIGS. 1 and 2, the frame 18 comprises at least one support member comprising two (2) pieces. The support member may comprise a base member 28 and an elongate bracket 30 extending vertically from the pipe 14. As shown in the front view of the base 28 in FIG. 2, the base member 28 is generally L-shaped having a vertical member 32 and an elongate horizontal member 34 on which the housing 20 is supported. The vertical member 32 may have one or more bolt holes 36 (FIGS. 3 and 4) that are used to attached the base member 28 to the elongate bracket 30.

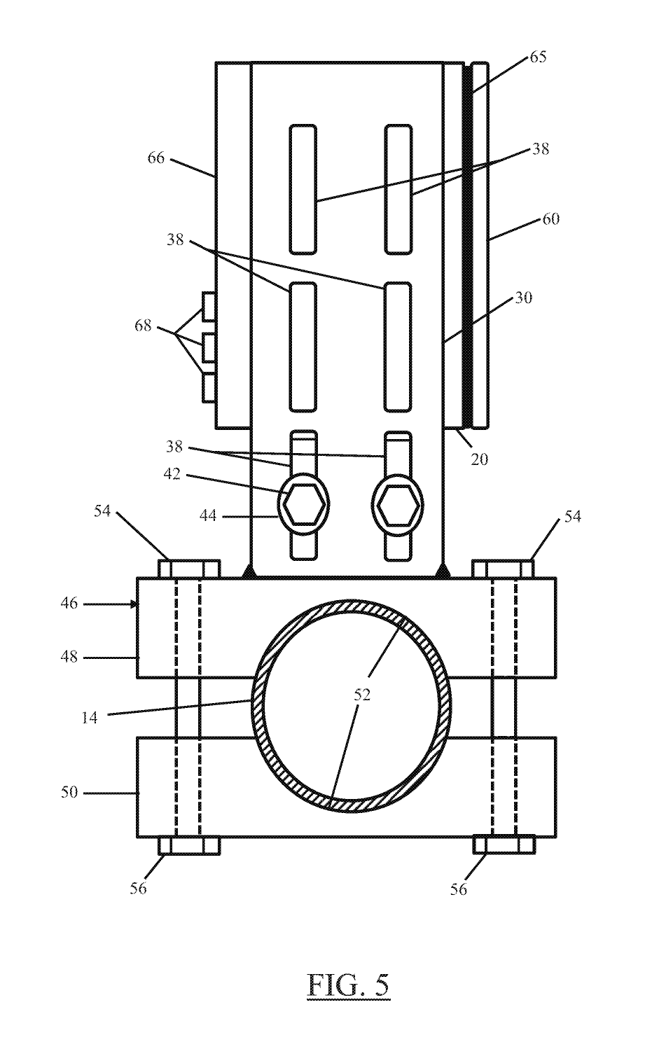

The elongate bracket 30 is shown in greater detail in the side view provided in FIG. 5. The bracket 30 comprises a plurality of vertically oriented slots 38. The slots 38 are sized to receive a fastener comprising a bolt 42. A washer 44 may placed between the bolt head and the bracket 30. The bolts 42 are sized to be received in the bolt holes 36 (FIGS. 3 and 4) of the base member 28. In this way the base member 28 may be secured to the elongate bracket 30. Further, use of elongate slots 38 permits the distance between the housing 20 and the pipe 14 to be adjusted to accommodate different valve stem lengths and larger or smatter valve assemblies.

A clamping assembly 46 is used to attach the elongate bracket 30 to the pipe 14. The clamping assembly 46 has a top member 48 and a bottom member 50. The top member 48 is disposed on the top of the pipe 14 and welded to the elongate member 30. The bottom member 50 is aligned with the top member on the bottom of the pipe 14. As shown in FIG. 1, the top and bottom members (48,50) may both have a U-shaped profile when viewed from the end. Viewed from the side, the top and bottom members (48,50) may have a notch 52 formed in both side walls of each member. The notches 52 may both have an arc that closely conforms to the radius of curvature of the pipe 14.

The frame 18 is connected to the pipe 14 by placing the top member 48 and elongate bracket 30 on the top of the pipe 14. The bottom member 50 is then placed on the bottom side of the pipe 14. A pair of bolts 54 (FIG. 5) are threaded through holes (not shown) formed in both the top 48 and bottom 50 members. Nuts 56 may be threaded onto the bottom of the bolts 54 and tightened to create a clamping force between the top member 48 and the bottom member 50. This clamping force secures the elongate bracket 30 to the pipe 14 to prevent movement of the elongate bracket 30 relative the pipe Once the elongate bracket 30 is secured, the base member 28 and housing 20 may be bolted onto the elongate member at a desired height above the pipe 14.

Preferably, the coupling 24 is positioned on the valve stem 16 first. Then, the drive shaft 58 (FIG. 2) is positioned within the coupling. Coupling the valve stern 16 and the drive shaft 58 permits the installer to judge the proper location for installation of the elongate bracket 30 relative the valve 12.

Returning to FIG. 1, the housing 20 is supported on the base member 28 and may be positioned to abut the elongate bracket 30. The housing 20 may be made from a plastic material that is weather resistant Weather resistance is important because the housing 20 is used to protect many of the components of the device 10 and is subject to a wide variety of weather conditions including harsh heat and severe cold.

The housing 20 is generally rectangular and may have an open side configured to receive a removable face plate 60 (FIG. 5). The face plate 60 may be secured to the housing 20 with a plurality of screws 62. Thus, a plurality of corresponding screw holes 64 (FIG. 2) may be formed in the housing 20 and positioned to align with the screws 62 (FIG. 1) supported in the face plate 60 (FIG. 5). A seal 65 may be positioned between the face plate 60 and the housing 20 to prevent the migration of water or other fluids into the housing through the space between the face plate and the housing.

The back wall 66 of the housing 20 may have one or more openings 68 (FIGS. 2 and 5) to permit lead wires 70 and 72 to enter the housing from the flow meter 74, an external power source 76, and any other external components of the device 10. The openings 68 may be fitted with elastomeric seals (not shown) that permit the wires (70,72) to pass through the openings, but seal the openings to prevent water from entering the housing through the openings. In the event one or more of the openings 68 are not used, the unused opening(s) may be plugged.

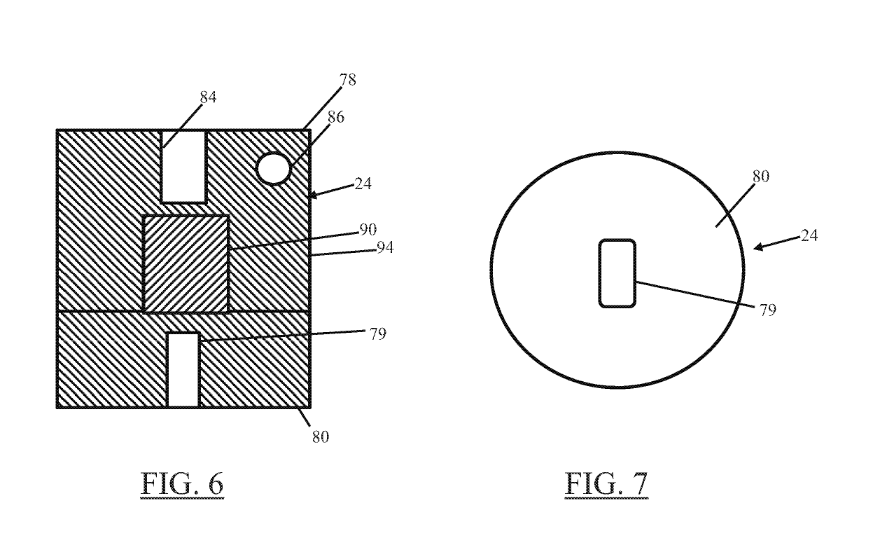

Referring to FIGS. 2 and 6, the coupling 24 has a first end 78 and a second end 80. The first end 78 is mounted on the drive shaft 58 of the motor 22. The second end 80 has an opening 79 configured to receive the valve stem 16. Opening 79 may be substantially round or may be elongated, as shown in FIG. 7, to conform to the shape of the valve stem 16.

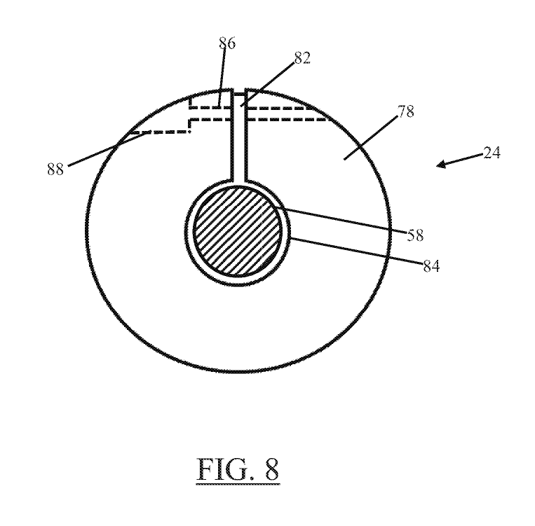

The first end 78 is shown from a top view of the coupling 24 in FIG. 8. The first end 78 of the coupling 24 generally comprises a split ring configuration having a slit 82 and a shaft receiving aperture 84. The drive shaft 58 is positioned within the aperture 84 and a set screw (not shown) is inserted in passage 86. The passage 86 may have a countersink portion 88 configured to support the head of the set screw so that it does not protrude from the profile of the coupling. As the set screw is threaded further into the passage 86 the edges of the slit 82 are pulled closer together to pinch the drive shaft 58. This causes the coupling 24 to be secured to the drive shaft 58 for rotation therewith.

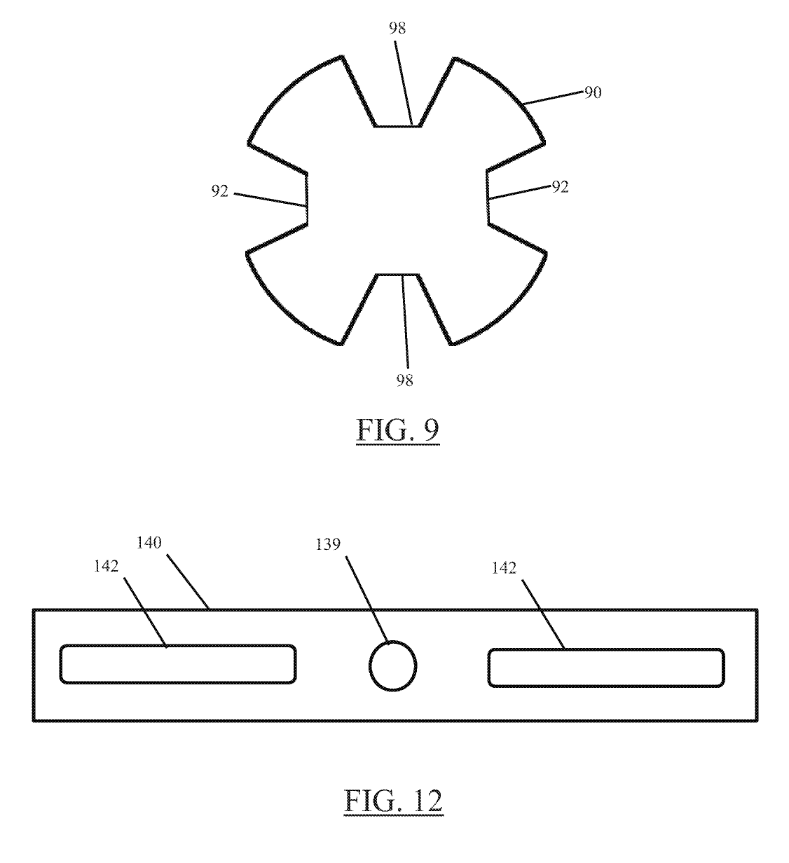

Referring again to FIGS. 2 and 6 and now FIG. 9, an adapter 90 is positioned between the first end 78 and the second end 80 and connects the two pieces together so that torque may be transmitted between the drive shaft 58 and the valve stem 16. As shown in FIG. 9, the adapter 90 may comprise a plurality of notches 92 and 94 configured to engage the first end 78 and the second end 80 of the coupling 24. For example tabs 94 (FIG. 2) of the first end 78 may be positioned within the notches 92 and tabs 96 of the second end 80 may be positioned within notches 98. In this way torque may be transmitted from the drive shaft 58 to the first end 78, through the adapter 90 to the second end 80, and to the valve stem 16.

Returning to FIG. 2, the motor 22 will be further discussed. The motor 82 is supported on the base member 28 within housing 20. The motor 22 has a body that is supported within the housing and a drive shaft 58 that passes through an opening 100 in the housing 20 and an opening 102 in the horizontal member 34. The motor 22 may be an electric motor that is powered by a battery 104. Preferably, the motor is a geared stepper motor that permits fine control of the valve by moving causing the valve to open or close incrementally to provide fine control over function of the valve.

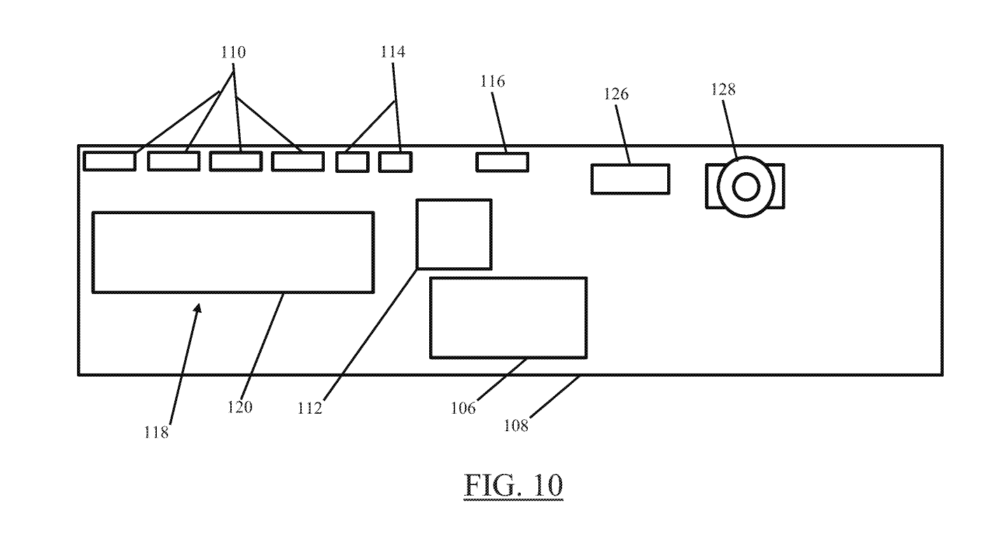

Operation of the motor 22 is directed by a controller 106 (FIG. 10). The controller 106 may comprise a computer micro-processor supported on a printed circuit board 108 (FIG. 10). The printed circuit board 108 is supported within the housing 20 on the top watt (FIG. 2). The controller 106 is programmed to direct operation of the motor 22 in response to data from the flow meter 74 (FIG. 1) and any other sensors used with the device 10. In response to flow rate data or pressure data, the controller directs the motor 22 to open or close the valve 12 in order to adjust the flow rate of fluid passing through the pipe 14. As used herein, the terms open and close do not necessarily mean all the way opened or completely closed. Rather, the controller 106 may direct the motor to open the valve more than it was already opened to increase flow through the pipe or the controller can instruct the valve to close slightly to decrease the flow rate through the pipe 14. Alternatively, the controller 106 can be programmed to direct the motor 22 to adjust the flow rate in response to user input.

Referring back to FIG. 1, the flow meter 74 is positioned upstream of the valve 12 in the pipe 14. The flow meter 74 may comprise any of the known flow meters used for measuring the flow of fluid through a tubular member. The flow meter 74 detects a flow of fluid through the pipe 14 and communicates the flow data to the controller 106. In response to the flow data, the controller directs operation of the motor 22 which in-turn controls operation of the valve 12. The flow meter 74 generates an analog signal that is transmitted to the controller via wire 70.

The signal travels along the wire 70 to one of a plurality of sensor input plugs 110 (FIG. 10) positioned on the printed circuit board 108. The sensor input plugs 110 may be configured to receive data from one or more pressure sensors, one or more temperature sensors, one or more flow sensors, or any other sensors suitable for fluidics applications.

An analog-to-digital converter 112 converts the analog output signals received from the sensors to digital signals for processing by the controller. The converter 112 may be placed on the printed circuit board 108. Likewise a digital-to-analog converter (not shown) is used to convert the digital output signal of the controller 106 to an analog signal that is used to direct operation of the motor 22. For this purpose, the circuit board 108 may have one or more digital to analog converter plugs 114 that are used to manage output signals to the motor 22.

A stepper plug 116 is provided on the circuit board 108 and is used to connect the controller 106 to the stepper motor 22 (FIG. 2). The output signals from the controller 106 are transmitted along wires (not shown) that connect the circuit board 108 to the motor 22 via the stepper plug 116.

A communication module 118 is supported in the housing 20 and configured to enable remote operation of the motor 22. The communications module 118 may comprise a cellular communication link comprising a cellular network card 120 supported on the circuit board 108, a cellular antenna 122 (FIG. 2) supported by the battery 104, and a separate communication module battery 124 (FIG. 2). A suitable cellular network card is the SARA-U260 professional grade UMTS/HSPA cellular module.

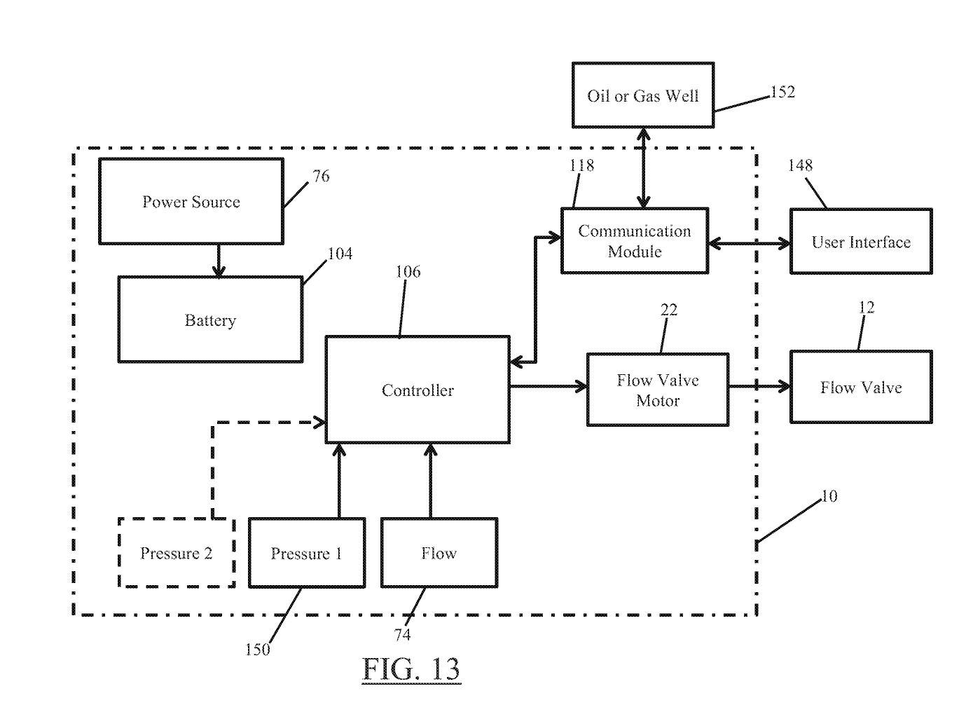

Referring to FIG. 13, the communication module 118 provides for two-way communication between the device 10 and a user interface 148. Accordingly, the user may receive real-time or delayed flow, pressure, and temperature data from the device 10. The operator may utilize this data to adjust the flow rate through the pipe 14 (FIG. 1) to manage the fluid flow. The user interface 148 may comprise a web site displayed on a computer screen or mobile device or a dedicated application installed on a mobile device.

The device 10 of the present invention may be connected to the injection well valve 12 and flow meter 74 and/or a pressure sensor 150 to provide control over the function of the injection well. The user may see that output from the oil or gas well 152 is above a desired output. In response, the operator may remotely command the device 10 to reduce the flow of fluid through the pipe 14 and into the injection well to decrease the output of the oil or gas well.

The command is transmitted from the user interface 148 to the controller 106 through the communication module 118. The controller 106 processes the command and outputs a signal to the flow valve motor 22. The motor 22 operates in response to the signal from the controller to actuate the flow valve 12.

Further, the device 10 may be programmed to receive data from the oil and gas well 152 automatically through the communication module 118. This data can be used by the device 10 to adjust the valve 12 to increase or decrease the flow of fluid through the pipe 14 to maintain a desired output from an oil and gas well 152 that is associated with the injection well. Thus, the device 10 of the invention may form part of a feedback loop with a hydrocarbon well. The loop is used to manage the operations of the hydrocarbon well by managing the injection of water into the formation by operation of the device 10 to control the valve 12.

In addition to receiving data from the flow meter 74, the controller 106 can also be configured to receive data from pressure sensors, temperature sensors, and other sensors suitable for fluidics applications. The information received from the sensors can be communicated to a server or to a network, where it can be stored and accessed by a user that may be remotely located from the device 10. An advantage of this system is that it automatically creates and stores a record of the conditions being monitored, Moreover, in response to the data received from the sensors, the remote user can send a signal back to the controller in order to adjust the valve. Alternatively, the controller can be configured to automatically control the motor 22 and adjust the valve 12 in response to data received from the flow meter 74 or sensors.

The components of the device 10 are powered by a battery 104 supported in the housing. A solar collector 76 (FIG. 1) may be used to recharge the battery 104. The solar collector 76 is supported on the pipe 14 using a clamping assembly 77 similar to the assembly 46 used to clamp the frame 18 to the pipe. The solar collector 76 may provide an renewable source of power to the device 10 and may be used to recharge the communication module battery 124. The battery 124 supplies power to the circuit board 108 via power plug 126. Power to the device 10 may be turned off or on using a toggle switch 128.

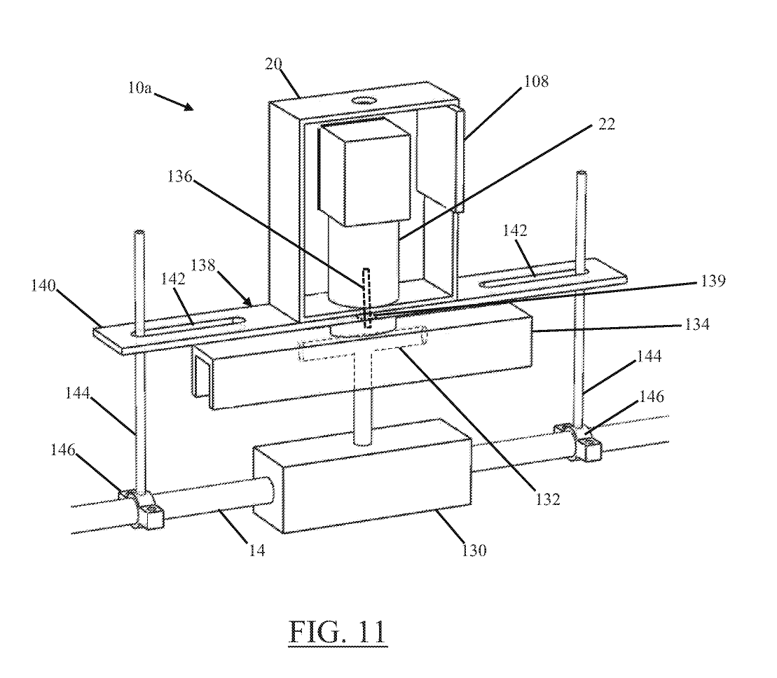

Shown in FIG. 11 is an alternate embodiment comprising device 10a in which the flow controller operates a valve 130 that has a handle 132. Turning the handle 132 in one direction causes the valve 130 to open and turning the handle in an opposite direction causes the valve to close. The flow controller has an arm 134 that engages the handle 132 to turn the handle and actuate the valve. The arm 134 may be composed of metal, plastic, or any other suitable material. The arm 134 is driven by the previously described motor 22 having a drive shaft 136. The arm 134 is mounted on the shaft 136 so that the arm rotates in a fixed relationship with the shaft. The arm 134 may be removable from the shaft 136 or the arm may be an integrated component on the shaft.

Continuing with FIG. 11 and referring now to FIG. 12, an alternative embodiment of the frame 138 is discussed. The frame 138 has a platform element 140 having a plurality of openings 142. The platform element 140 may be generally elongate and configured to support the housing 0 at the proximate midpoint of the element. The platform element 138 has an opening 139 at its mid-point to allow the drive shaft 58 of the motor 22 to pass through the platform element and to the arm 134.

The openings 142 are formed in the platform element 140 and positioned on either side of the housing 20. The openings 142 are elongate slots that permit variable placement of a plurality of legs 144 that extend through the openings. The legs 144 may be of a height that allows the platform element 140 to be adjustable to position the arm 134 at the correct height of the valve handle 132. A collar 146 connects each leg 144 to the pipe 14.

Various modifications and variations can be made in the present invention without departing from the scope and spirit of the invention. It is intended that the present invention cover such modifications and variations as come within the scope and spirit of the appended claims and their equivalents.

What is claimed is:

1. A device for actuating a valve having a valve stem, comprising:
a frame;
a motor supported on the frame, the motor having a rotatable shaft; and
a coupling having a first end and a second end, the first end mounted on the shaft and the second end mounted on the valve stern.

2. The device of claim I wherein the motor is a stepper motor.

3. The device of claim 1 further comprising:
a controller configured to direct operation of the motor.

4. The device of claim 1 wherein the frame comprises:
at least one support member comprising:
a base; and
an elongate bracket extending from the base, the bracket having a plurality of openings extending through the bracket.

5. The device of claim 4 further comprising:
a clamp attached to the base.

6. The device of claim I wherein the frame comprises:
a platform element having a plurality of openings; and
a plurality of legs extending through the openings, wherein the platform element is supported on the plurality of legs.

7. The device of claim 6 further comprising:
a plurality of collars attached to the legs, wherein the plurality of collars attach the legs to a pipeline.

8. The apparatus of claim I, further comprising:
a plurality of pipe members connected via the valve; and
a flow meter configured to detect a flow of a fluid through the pipe members and to communicate flow data to the controller, wherein the controller controls the motor in response to the flow data.

9. The device of claim 1 further comprising:
a communication module configured to enable remote operation of the motor.

10. The device of claim 10 wherein the communication module is a cellular communication link.

11. A device comprising:
a frame;
a housing supported on the frame, the housing having at least one opening;
a motor having a body and a rotatable shaft, the body positioned within the housing and the shaft extending through the housing opening;
a coupling having a first end and a second end, the first end mounted on the shaft, and the second end having an opening configured to receive a valve stem;
a controller configured to direct operation of the motor; and
a communication module configured to enable remote operation of the motor.

12. A kit, comprising:
a vertical frame member having a clamping assembly and an opening formed in the frame member;
a horizontal frame member demountably connected to the vertical frame member with a fastener disposed in the opening;
a control unit supported on the horizontal frame member and comprising:
a motor having a rotatable shaft;
a coupler connected to the rotatable shaft for rotation therewith; and
a controller configured to direct operation of the motor.

13. The kit of claim 13, further comprising:
a transducer configured for conversion of analog flow data to digital flow signals;
and in which the controller is configured to direct operation of the motor in response to digital flow signals.

14. The kit of claim 13, further comprising:
an arm mountable on the shaft of the motor.

15. The kit of claim 13 in which the shaft of the motor extends through an opening formed in the horizontal frame member.

16. The kit of claim 13 in which the coupler is configured to grip an object of circular cross-sectional shape.

17. The kit of claim 13 further comprising an external power source.
